(19) United States
(12) Patent Application Publication
(10) Pub. No.: US 2023/0229766 A1
(43) Pub. Date: Jul. 20, 2023

(54) BACKDOOR INSPECTION DEVICE, BACKDOOR INSPECTION METHOD, AND COMPUTER-READABLEMEDIUM

(71) Applicant: NEC Corporation, Minato-ku, Tokyo (JP)

(72) Inventors: Takayuki Sasaki, Tokyo (JP); Yusuke Shimada, Tokyo (JP)

(73) Assignee: NEC Corporation, Minato-ku, Tokyo (JP)

(21) Appl. No.: 18/007,629

(22) PCT Filed: Jun. 3, 2020
(86) PCT No.: PCT/JP2020/021920

§ 371 Date: Dec. 1, 2022

(51) Int. Cl. G06F 21/55; G06F 21/14; G06F 21/57

(52) U.S. Cl. CPC G06F 21/556; G06F 21/14; G06F 21/577; G06F 2221/033

(57) ABSTRACT

An identifying unit identifies, in a backdoor inspection device, a plurality of code blocks included in software to be inspected. An inspection unit executes backdoor inspection processing on the software to be inspected for the plurality of the code blocks that are identified by the identifying unit. An adjustment processing unit executes adjustment processing including obfuscation processing on the software to be inspected. A certificate generation unit generates a first certificate containing at least information on a result of the backdoor inspection processing. An output unit outputs the software to be inspected on which the adjustment processing has been performed together with the first certificate.

### TECHNICAL FIELD

The present disclosure relates to a backdoor inspection device, a backdoor inspection method, and a computer-readable medium.

### BACKGROUND ART

Infrastructures and enterprise systems have become complicated. Thus, the infrastructure or enterprise system is constituted by not only the devices of a single company but by procuring devices of various enterprises from outside suppliers and combining the procured devices.

However, in recent years, numerous incidents have been reported in which hidden functions that users are not aware of or unexpected functions for users in terms of software (firmware) and hardware of such devices are found. In other words, numerous incidents related to “backdoors” have been reported. A “back door” can be defined, for example, as a feature incorporated as a part of software that includes multiple functions and which is undisclosed to and unwanted by users.

A method of detecting a specific type of backdoor is disclosed in, for example, Non-Patent Literature 1.

### CITATION LIST

### Non-Patent Literature

Non-Patent Literature 1: F. Schuster and T. Holz, “Towards reducing the attack surface of software backdoors,” In Proceedings of the 2013 ACM SIGSAC conference on Computer & communications security (CCS), 2013.

### SUMMARY OF INVENTION

### Technical Problem

The inventors of the present disclosure have found that there are, for example, a need for equipment manufacturers to prove that their equipment in which software is installed does not contain backdoors in the installed software and a need for equipment manufactures to obfuscate software installed in their equipment from the perspective of intellectual property protection. That is, the inventors of the present disclosure have found that there is a need to realize both proof of software trustability and obfuscation of software. Note that obfuscation processing includes, for example, software encrypting processing, embedding processing of dummy codes in software, or the like.

An object of the present disclosure is to provide a backdoor inspection device, a backdoor inspection method, and a computer-readable medium that can realize both proof of software trustability and obfuscation of software.

### Solution to Problem

According to a first aspect of the present disclosure, a backdoor inspection device includes:

identifying means for identifying a plurality of code blocks included in software to be inspected;

inspection means for executing backdoor inspection processing on the software to be inspected for the plurality of the code blocks that are identified;

processing means for executing adjustment processing including obfuscation processing on the software to be inspected;

certificate generation means for generating a first certificate containing at least information on a result of the backdoor inspection processing; and

output means for outputting the software to be inspected on which the adjustment processing has been performed together with the first certificate.

According to a second aspect of the present disclosure, a backdoor inspection method includes:

identifying a plurality of code blocks included in software to be inspected;

executing backdoor inspection processing on the software for the plurality of the code blocks that are identified;

executing adjustment processing including obfuscation processing on the software;

generating a first certificate containing at least information on a result of the backdoor inspection processing; and

outputting the software on which the adjustment processing has been performed together with the first certificate.

According to a third aspect of the present disclosure, a non-transitory computer-readable medium stores a program for causing a backdoor inspection device to perform processes of:

identifying a plurality of code blocks included in software to be inspected;

executing backdoor inspection processing on the software for the plurality of the code blocks that are identified;

executing adjustment processing including obfuscation processing on the software;

generating a first certificate containing at least information on a result of the backdoor inspection processing; and

outputting the software on which the adjustment processing has been performed together with the first certificate.

### Advantageous Effects of Invention

According to the present disclosure, it is possible to provide a backdoor inspection device, a backdoor inspection method, and a computer-readable medium that can realize both proof of software trustability and obfuscation of software.

### BRIEF DESCRIPTION OF DRAWINGS

FIG. 1 is a block diagram showing an example of a backdoor inspection device according to a first example embodiment;

FIG. 2 is a block diagram showing an example of a backdoor inspection device according to a second example embodiment;

FIG. 3 is a flowchart showing an example of processing operation of the backdoor inspection device according to the second example embodiment;

FIG. 4 is a block diagram showing an example of an identifying unit according to a third example embodiment;

FIG. 5 is a diagram for explaining a control flow graph; and

FIG. 6 is a diagram showing an example of hardware configuration of a backdoor inspection device.

### EXAMPLE EMBODIMENT

The following will describe example embodiments of the present invention with reference to the drawings. Note that in each drawing, the same or corresponding elements are designated by the same signs, and duplicate description will be omitted

### First Example Embodiment

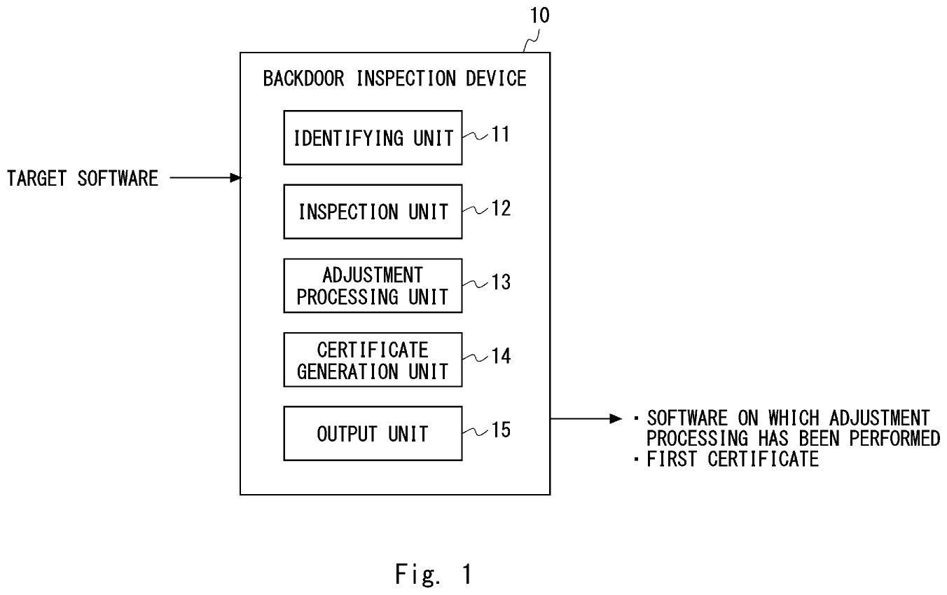

FIG. 1 is a block diagram showing an example of a backdoor inspection device according to a first example embodiment. A backdoor inspection device 10 shown in FIG. 1 is used, for example, in an authentication authority. The backdoor inspection device 10 receives software sent from, for example, an equipment manufacturer. The aforementioned software is software to be inspected, and is sometimes simply referred to as “target software” in the following description. Target software may be a source code which is a pre-compiled code or a binary code which is a post-compiled code.

The backdoor inspection device 10 shown in FIG. 1 includes an identifying unit 11, an inspection unit 12, an adjustment processing unit 13, a certificate generation unit 14, and an output unit 15.

The identifying unit 11 identifies a plurality of “code blocks” included in the target software. The “code blocks” may be functional blocks corresponding to the functions included in the target software or may be basic blocks whose unit is smaller than that of the functional blocks.

The inspection unit 12 executes backdoor inspection processing on the target software for the plurality of the code blocks that are identified by the identifying unit 11. Here, there are technical difficulties in executing the inspection processing on the target software for which obfuscation processing has been performed. However, since the inspection unit 12 executes the inspection processing on the target software for which “obfuscation processing” is not performed yet, it is possible to reliably execute the inspection processing.

The adjustment processing unit 13 executes “adjustment processing” including “obfuscation processing” on the target software. As described above, “obfuscation processing” includes software encrypting processing, embedding processing of dummy codes in target software, or the like. Note that the adjustment processing unit 13 may execute adjustment processing when the result of the backdoor inspection processing indicates that there are no code blocks, which are backdoors, in the target software and execute adjustment processing when the result of the backdoor inspection processing indicates that there are code blocks, which are backdoors, in the target software.

The certificate generation unit 14 generates a certificate containing at least information on the result of the inspection processing (hereinbelow also referred to as a “first certificate”). Information on the result of the inspection processing includes, for example, information indicating whether or not there are code blocks, which are backdoors, in the target software.

The output unit 15 outputs the target software on which adjustment processing has been performed together with the first certificate. Accordingly, the software on which adjustment processing has been performed and the first certificate are transmitted together to the equipment manufacturer.

The configuration of the backdoor inspection device 10 described above allows for realization of both proof of software trustability and obfuscation of software. Incidentally, when the equipment manufacturer performs obfuscation processing of the target software after receiving the certificate regarding trustability of the target software, the certificate would be meaningless. On the other hand, the backdoor inspection device 10 allows for realization of both proof of software trustability and obfuscation of software and thus the aforementioned problem does not occur.

Note that the backdoor inspection device 10 executes the backdoor inspection method. The backdoor inspection method includes: identifying a plurality of code blocks included in software, which is a target of inspection; executing backdoor inspection processing on the software for the plurality of the code blocks that are identified; executing adjustment processing including obfuscation processing on the software; generating a first certificate containing at least information on the result of the backdoor inspection processing; and outputting the software on which adjustment processing has been performed together with the first certificate.

### Second Example Embodiment

A second example embodiment relates to a more specific example embodiment.

<Configuration Example of Backdoor Inspection Device>

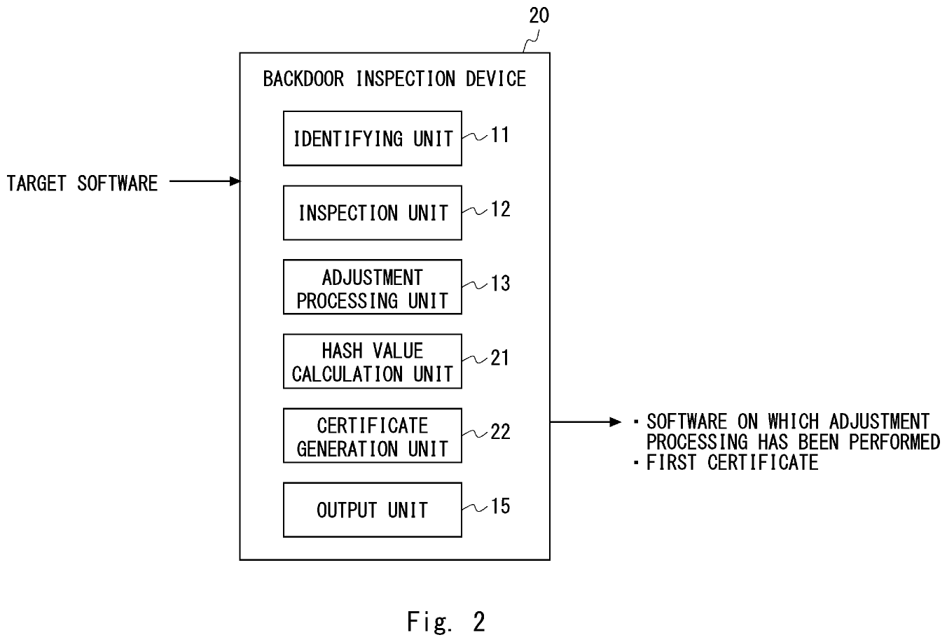

FIG. 2 is a block diagram showing an example of a backdoor inspection device according to a second example embodiment. The backdoor inspection device 20 shown in FIG. 2 includes the identifying unit 11, the inspection unit 12, the adjustment processing unit 13, the output unit 15, a hash value calculation unit 21, and a certificate generation unit 22.

The hash value calculation unit 21 calculates a hash value of a target software on which adjustment processing has been performed by the adjustment processing unit 13.

The certificate generation unit 22 generates a first certificate containing information on the result of the inspection processing and a hash value calculated by the hash value calculation unit 21. For example, the certificate generation unit 22 generates, at the timing when the inspection processing has been completed by the inspection unit 12, a certificate containing at least information on the result of the inspection processing (hereinbelow also referred to as a “second certificate”). Then, the certificate generation unit 22 generates, at the timing when the hash value has been calculated by the hash value calculation unit 21, the first certificate by appending the hash value to the second certificate. That is, the first certificate in the second example embodiment contains the result of the backdoor inspection processing and the hash value that associates the result of the backdoor inspection processing with the target software on which adjustment processing has been performed.

<Example of Operation of Backdoor Inspection Device>

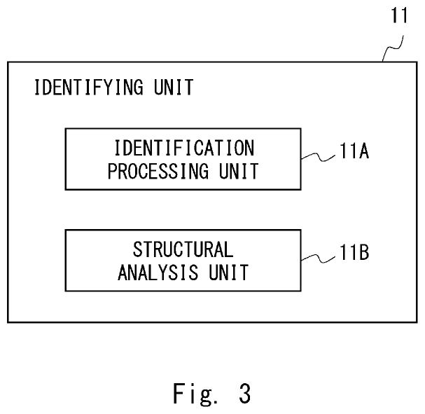

An example of processing operation of the backdoor inspection device 20 having the aforementioned configuration will be described. FIG. 3 is a flowchart showing an example of processing operation of the backdoor inspection device according to the second example embodiment. The processing flow shown in FIG. 3 starts when, for example, the backdoor inspection device 20 receives a target software.

The identifying unit 11 identifies, in the door inspection device 20, a plurality of code blocks included in the target software (Step S101).

The inspection unit 12 executes backdoor inspection processing on the target software for the plurality of the code blocks that are identified (Step S102).

The certificate generation unit 22 generates a second certificate containing the result of the backdoor inspection processing (Step S103).

The adjustment processing unit 13 executes adjustment processing on the target software (Step S104).

The hash value calculation unit 21 calculates the hash value of the target software on which adjustment processing has been performed (Step S105).

The certificate generation unit 22 generates the first certificate by appending the hash value to the second certificate (Step S106).

The output unit 15 outputs the target software on which adjustment processing has been performed together with the first certificate (Step S107).

According to the second example embodiment described above, the hash value calculation unit 21 of the backdoor inspection device 20 calculates the hash value of the target software on which adjustment processing has been performed by the adjustment processing unit 13. The certificate generation unit 22 generates the first certificate containing information on the result of the backdoor inspection processing and a hash value calculated by the hash value calculation unit 21.

The configuration of the backdoor inspection device 20 described above allows generation of a first certificate containing information on the result of the backdoor inspection processing and a hash value that associates the information on the result of the backdoor inspection processing with the target software on which adjustment processing has been performed, whereby it is possible to enhance trustability of the information on the result of the backdoor inspection processing (that is, trustability of the first certificate).

### Modified Examples

<1> Note that the adjustment processing may include, in addition to or in place of the obfuscation processing, “security function addition processing” performed by rewriting codes. For example, the adjustment processing unit 13 may embed, in the target software, a “function” in accordance with which the memory of own device is scanned on a periodic basis and checked for tampering as “security function addition processing”. Specifically, the adjustment processing unit 13 may re-write the target software so as to add, to the target software, an execution code for a function in accordance with which tampering is checked for so that the added execution code is called.

Further, the adjustment processing may include, in addition to or in place of the obfuscation processing, “deletion processing of debugging information” included in the target software. Examples of debugging information include a function name, a variable name, and information in association with lines of a source code. For example, when the target software is Linux (registered trademark), the adjustment processing unit 13 may delete these using a strip command.

<2> The certificate generation unit 22 may include, in the first certificate, the signature of the inspection authority where the backdoor inspection device 20 is installed. Further, the certificate generation unit 22 may include the signature of the backdoor inspection device 20 in the first certificate. Further, the certificate generation unit 22 may include the hash value or the name of the target software on which adjustment processing is not performed yet in the first certificate. Further, the certificate generation unit 22 may include, in the first certificate, the version of the backdoor inspection device 20, the ID of the analyst who performed the analysis by using the backdoor inspection device 20, the signature of the analyst, the organization to which the analyst belongs, the name of the analyst, and the like. Further, the certificate generation unit 22 may include, in the first certificate, information about the positions of the code blocks, which are backdoors, in the target software as the information on the result of the backdoor inspection processing.

### Third Example Embodiment

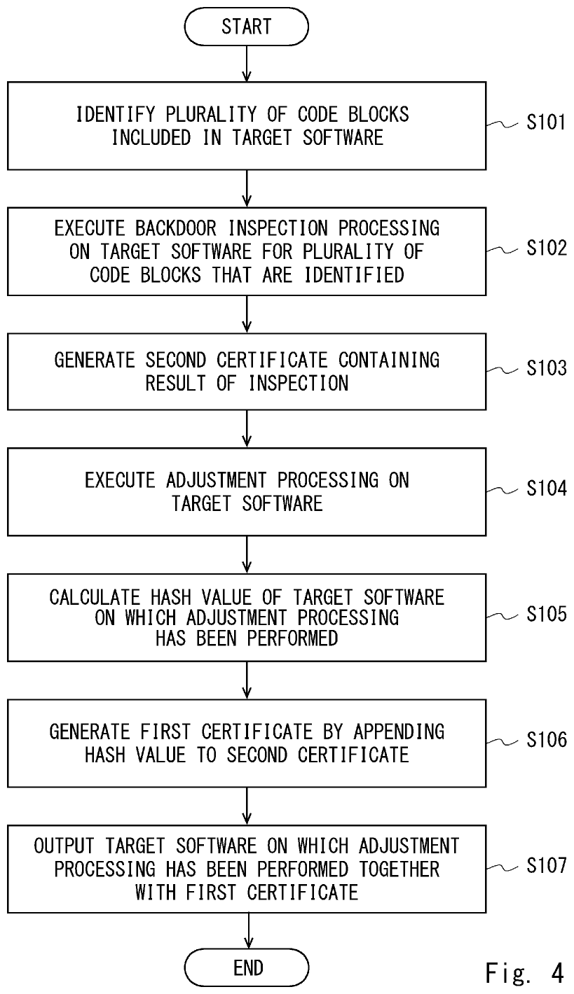

A third example embodiment relates to a configuration example of an identifying unit. FIG. 4 is a block diagram showing an example of an identifying unit according to the third example embodiment. The identifying unit 11 shown in FIG. 4 includes an identification processing unit 11A and a structural analysis unit 11B.

The identification processing unit 11A identifies the “specific code blocks” corresponding to the “predetermined specific functions” in the target software. Examples of the “predetermined specific functions” include an “interface function”, an “authentication function (authentication routine)” and a “command function (server routine)”. That is, the “predetermined specific functions” are functions that are followed by various functions. That is, the “predetermined specific functions” correspond to the code blocks, each code block serving as a starting point in a control flow graph of the target software.

The identification processing unit 11A may identify the specific code blocks by using, for example, an “identification rule table (a first identification table)” in which a plurality of the specific functions and the characteristics of the specific code blocks corresponding to the specific functions are associated with each other. In this case, the identification processing unit 11A identifies a part of the software that matches the characteristics of the specific code blocks retained in the identification rule table as the specific code block. Further, the identification processing unit 11A may identify the specific code blocks by executing one or a plurality of algorithms or modules for identifying the specific functions instead of using the identification rule table.

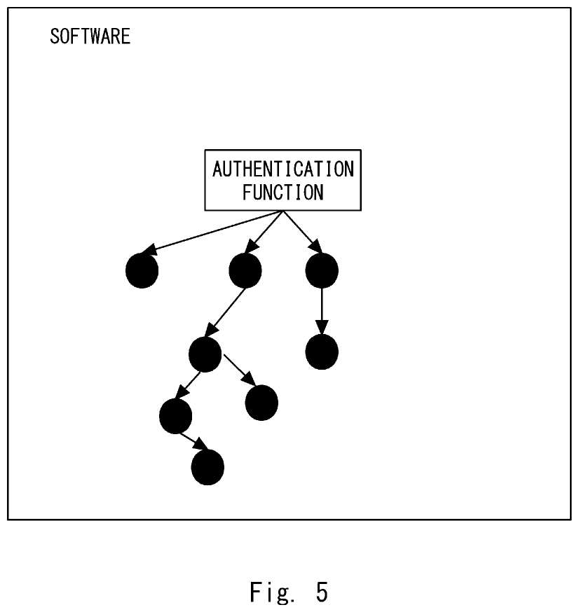

The structural analysis unit 11B analyzes the configuration of the target software and identifies the code blocks corresponding to the functions other than the specific code function by proceeding in accordance with the control flow that starts from the specific code block identified by the identification processing unit 11A. For example, the structural analysis unit 11B creates a control flow graph like the one shown in FIG. 5 by proceeding in accordance with the control flow that starts from the code block of the authentication function identified by the identification processing unit 11A. Then, the structural analysis unit 11B identifies the code blocks corresponding to the functions other than the specific function by using an “identification rule table (a second identification table)”. In the “second identification table”, the types of the code blocks that serve as starting points are associated with the characteristics of the code blocks that are to be identified in accordance with the types thereof. For example, in the “second identification table”, the “code block for the certification function” which is a code block that serves as a starting point is associated with the “code block that is present after proceeding with the certification routine in the control flow graph” for the “characteristics of the code block to be identified”. Further, for example, in the “second identification table”, the “code block for the command server function” which is a code block that serves as a starting point is associated with a “functional block that includes a command or a function that is dispatched by a parser” for the “feature of the code block to be identified”. Note that in the control flow graph shown in FIG. 3, the “code block for the authentication function” and “the code block to be identified (indicated by circles in FIG. 5)” can be also be referred to as “nodes”. Further, in the control flow graph shown in FIG. 5, the arrows indicate the control flow.

Then, for example, the inspection unit 12 detects “a path (a rogue path)” leading to the code blocks identified by the structural analysis unit 11B (i.e. execution parts of the identified code blocks which require authentication) without passing through the code block for the authentication function in the control flow graph created by the structural analysis unit 11B.

Further, the inspection unit 12 detects, in the control flow graph created by the structural analysis unit 11B, code blocks including commands (or functions) that are not prescribed in the specification document.

### Other Example Embodiments

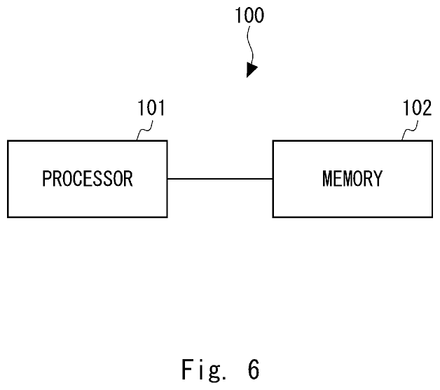

FIG. 6 is a diagram showing an example of hardware configuration of a backdoor inspection device. In FIG. 6, the backdoor inspection device 100 includes a processor 101 and a memory 102. The processor 101 may be, for example a microprocessor, a MPU (Micro Processing Unit), or a CPU (Central Processing Unit). The processor 101 may include a plurality of processors. The memory 102 is configured of a combination of a volatile memory and a non-volatile memory. The memory 102 may include a storage disposed away from the processor 101. In this case, the processor 101 may access the memory 102 through an unillustrated I/O interface.

The backdoor inspection devices 10, 20 according to the first and the second example embodiments, respectively, may have the hardware configuration shown in FIG. 6. The identifying unit 11, the inspection unit 12, the adjustment processing unit 13, the certificate generation units 14, 22, the output unit 15, and the hash value calculation unit 21 of the backdoor inspection devices 10, 20 according to the first and the second example embodiment may be realized by having the processor 101 read and execute the program stored in the memory 102.

The program can be stored by using any of various types of non-transitory computer-readable media and supplied to the backdoor inspection devices 10, 20. Examples of non-transitory computer-readable media include magnetic storage media (e.g., flexible disks, magnetic tapes, and hard disk drives), magneto-optical storage media (e.g., magneto-optical disks). Examples of non-transitory computer-readable media further include CD-ROM (Read Only Memory), CD-R, and CD-R/W. Further, examples of non-transitory computer-readable media include semiconductor memory. Examples of semiconductor memory include mask ROM, PROM (Programmable ROM), EPROM (Erasable PROM)), flash ROM, and RAM (Random Access Memory). The program may also be supplied to the backdoor inspection devices 10, 20 through any of various types of transitory computer-readable media. Examples of the transitory computer-readable media include electrical signals, optical signals, and electromagnetic waves. The transitory computer-readable media can supply the program to the backdoor inspection devices 10, 20 via a wired communication path, such as an electric wire and an optical fiber, or a wireless communication path.

Although the present invention has been described with reference to the example embodiments, the present invention is not limited to the above. Various changes that can be understood by those skilled in the art can be made to the configuration and details of the present disclosure within the scope of the present invention.

### REFERENCE SIGNS LIST

10 BACKDOOR INSPECTION DEVICE
11 IDENTIFYING UNIT
11A IDENTIFICATION PROCESSING UNIT
11B STRUCTURAL ANALYSIS UNIT
12 INSPECTION UNIT
13 ADJUSTMENT PROCESSING UNIT
14 CERTIFICATE GENERATION UNIT
15 OUTPUT UNIT
20 BACKDOOR INSPECTION DEVICE
21 HASH VALUE CALCULATION UNIT
22 CERTIFICATE GENERATION UNIT

What is claimed is:

1. A backdoor inspection device comprising:
at least one memory storing instructions, and
at least one processor configured to execute, according to the instructions, a process comprising:
identifying a plurality of code blocks included in software to be inspected;
executing backdoor inspection processing on the software to be inspected for the plurality of the code blocks that are identified;
executing adjustment processing including obfuscation processing on the software to be inspected;
generating a first certificate containing at least information on a result of the backdoor inspection processing; and
outputting the software to be inspected on which the adjustment processing has been performed together with the first certificate.

2. The backdoor inspection device according to claim 1, wherein the process includes calculating a hash value of the software to be inspected on which the adjustment processing has been performed,
wherein the generating the first certificate includes
generating the first certificate containing the information on the result of the backdoor inspection processing and the calculated hash value.

3. The backdoor inspection device according to claim 2, wherein the generating the first certificate includes:
generating, at a timing when the backdoor inspection processing has been completed, a second certificate containing the information on the result of the backdoor inspection processing; and
generating, at a timing when the hash value has been calculated, the first certificate by appending the hash value to the second certificate.

4. The backdoor inspection device according to claim 1, wherein the adjustment processing includes security function addition processing performed by rewriting codes.

5. The backdoor inspection device according to claim 1, wherein the adjustment processing includes deletion processing of debugging information contained in the software.

6. The backdoor inspection device according to claim 1, wherein the executing adjustment processing includes executing the adjustment processing when the result of the backdoor inspection processing indicates that there are no code blocks, which are backdoors, in the software and not executing the adjustment processing when the result of the backdoor inspection processing indicates that there are code blocks, which are backdoors, in the software.

7. A backdoor inspection method comprising:
identifying a plurality of code blocks included in software to be inspected;
executing backdoor inspection processing on the software for the plurality of the code blocks that are identified;
executing adjustment processing including obfuscation processing on the software;
generating a first certificate containing at least information on a result of the backdoor inspection processing; and
outputting the software on which the adjustment processing has been performed together with the first certificate.

8. A non-transitory computer-readable medium storing a program for causing a backdoor inspection device to perform processes of:
identifying a plurality of code blocks included in software to be inspected;
executing backdoor inspection processing on the software for the plurality of the code blocks that are identified;
executing adjustment processing including obfuscation processing on the software;
generating a first certificate containing at least information on a result of the backdoor inspection processing; and
outputting the software on which the adjustment processing has been performed together with the first certificate.
